(19) United States
(12) Patent Application Publication
(10) Pub. No.: US 2008/0279458 A1
(43) Pub. Date: Nov. 13, 2008

(54) Imaging system for shape measurement of partially-specular object and method thereof

(75) Inventors: Deok-Hwa Hong, Daejeon (KR); Joong-Ki Jeong, Daejeon (KR); Hyung-Suck Cho, Daejeon (KR)

Correspondence Address: NATH & ASSOCIATES, 112 South West Street, Alexandria, VA, 22314, US

(73) Assignee: KOREA ADVANCED INSTITUTE OF SCIENCE AND TECHNOLOGY, Daejeon (KR)

(21) Appl. No.: 12/068,645

(22) Filed: Feb. 8, 2008

(30) Foreign Application Priority Data
May 9, 2007 (KR) 10-2007-0044961

(51) Int. Cl. G06K 9/76

(52) U.S. Cl. 382/211

(57) ABSTRACT

The present invention can perform the optical measurement in the partially-specular object by preventing a generation of light saturation and blooming for an object with partially-specular characteristics by lowering the transmittance of specular lobe through the spatial light modulator. Therefore, the present invention can widen the measurement range up to the partially-specular object in the state where the advantages of the active optical measurement method of contactless, rapid measurement, and high precision are maintained.

### BACKGROUND OF THE INVENTION

This application claims priority to and the benefit of Korean Patent Application No. 10-2007-0044961, filed on May 9, 2007 in the Korean Intellectual Property Office, the entire content of which is incorporated herein by reference.

1. Field of the Invention

The present invention relates to an imaging system for shape measurement of an object and a method thereof, and more specifically to an imaging system for shape measurement of a partially-specular object and a method thereof capable of performing the optical measurement of the partially-specular object by controlling attenuation rate using a spatial light modulator.

2. Description of the Related Art

As noted, a shape measurement technology and a test technology of an object have been studied for a long time. Among others, an optical measurement method having advantages of contactless, rapid measurement time, and high precision has been spotlighted.

However, the optical measurement method cannot obtain accurate image information due to a generation of light saturation and blooming by specular lobe when measuring a partially-specular object, thereby causing a problem that the optical measurement cannot be performed.

In order to solve the problem, technologies for measuring the shape through a reflecting angle of scanned light have been developed. As one of these technologies, Korean Patent Laid-Open No. 1997-002296, which is a technology for shape measurement of a partially-specular object using a ring light source, discloses a technology of “Visual sensing device for testing specular object and method thereof”

The aforementioned “Visual sensing device for testing specular object and method thereof” is to perform the test for the specular object that had difficulties testing, by ascending and descending the ring light source in a circular shape emitting light for testing the specular object and making iso-inclination contours with the same reflecting angles. However, this method has a disadvantage of consuming a lot of time for processing the image associated with the movement of the ring light source, etc.

Also, since the “Visual sensing device for testing specular object and method thereof” performs the test using the iso-inclination contours, this method does not perform accurate shape measurement as well as cannot perform the measurement of many regions at a time.

And, Korean Patent Laid-Open No. 1995-0010723 discloses “Visual sensing device for soldering test” applied to a soldering test with characteristics of partial reflection specular surface.

The “Visual sensing device for soldering test”, which is a system proposed for the measurement of the solder joint with the specular reflection characteristics, identifies the reflecting angle of laser beam through a laser scanning using a galvanometer and a light receiving part formed of a cylindrical frame of a retroreflecting material so that it can test the solder joint.

However, the “Visual sensing device for soldering test” has a complicated hardware construction and cannot perform the measurement of spacious region at a time.

### SUMMARY OF THE INVENTION

The present invention proposes to solve the aforementioned problems of the related art. It is an object of the present invention to provide an imaging system for shape measurement of a partially-specular object and a method thereof capable of performing an optical measurement even in a partially-specular object by preventing an occurrence of light saturation and blooming by controlling attenuation rate of specular lobe using a spatial light modulator having an active vision measurement system.

In order to accomplish the object, an imaging system for shape measurement of a partially-specular object according to the present invention comprises: a luminous means irradiating light on a surface of a partially-specular object; a light receiving means having a spatial light modulator measuring the shape information of the partially-specular object through light reflected from the surface of the partially-specular object and controlling the attenuation rate of pixels corresponding the points light-saturated in a camera; and a controlling means obtaining final image information wherein the light saturation and blooming phenomena do not occur, by identifying pixels wherein the light saturation occurs and controlling the attenuation rate of pixels in the spatial light modulator corresponding thereto.

The spatial light modulator of the present invention may be positioned on an imaging surface that is first imaged in order to control, per pixel, light quantity formed on a charge coupled device (CCD) plane for a camera that is a second imaging surface or positioned on a position slightly deviating from the imaging surface that is first imaged so that the pixel itself in the spatial light modulator is not imaged on the camera. Such a spatial light modulator controls the light quantity by the specular lobe which is reflected from the surface of the partially-specular object and incidented on camera.

In accordance with the present invention, it is provided a method for shape measurement of a partially-specular object using an imaging system constituted as above. The method comprises the steps of: irradiating light from a luminous means on a surface of a partially-specular object; identifying a light saturated position using a controlling means after all light reflected from the surface of the partially-specular object is transmitted through a spatial light modulator and an image at that time is obtained from the controlling means through the camera; and obtaining the shape of the object through final image information wherein the light saturation and the blooming do not occur, by controlling the attenuation rate of pixels in the spatial light modulator corresponding to CCD pixels where the light saturation occurs.

The present invention can obtain the shape information using an active optical measurement method interpreting the final image information wherein the light saturation and the blooming do not occur. At this time, as the active optical measurement method, a phase measuring profilometry obtaining the three-dimensional shape information of the object by interpreting a change in a fringe pattern projected on the surface of the object may be used.

### BRIEF DESCRIPTION OF THE DRAWINGS

These and/or other objects, features, aspects, and advantages of the invention will be more fully described in the following detailed description for preferred embodiments and examples, taken in conjunction with the accompanying drawings. In the drawings:

FIG. 1 is a schematic view showing a constitution of an imaging system for shape measurement of partially-specular object and an influence by the specular lobe of an object according to one embodiment of the present invention;

FIGS. 2 and 3 are photographs showing a state where a fringe pattern is distorted by light saturation through an image of a solder joint that is a kind of partially-specular object;

FIG. 4 is a photograph showing a printed circuit board (PCB) image in a state not controlling the attenuation rate using the spatial light modulator of FIG. 1;

FIG. 5 is a photograph showing a printed circuit board (PCB) image in a state controlling the attenuation rate using the spatial light modulator of FIG. 1;

FIGS. 6 and 7 are photographs comparing an improvement effect of image according to the control of attenuation rate by magnifying some images shown in FIGS. 4 and 5;

FIG. 8 is a photograph showing a light modulation mask of the spatial light modulator to obtain an image of FIG. 5 improved by the spatial light modulator;

FIGS. 9 to 11 are photographs comparing an image state before and after the improvement by means of the imaging system for shape measurement of the partially-specular object according to one embodiment of the present invention; and

FIG. 12 is a photograph showing a phase image of an object shape obtained by means of the imaging system for shape measurement of the partially-specular object according to one embodiment of the present invention.

### DETAILED DESCRIPTION OF THE INVENTION

Hereinafter, embodiment of the present invention will be described with reference to the attached drawings. However, the embodiments are intended to illustrate the invention and do not limit the scope of the present invention. When referring to the drawings the same reference numerals are used throughout the different drawings to designate the same or similar components in the following description of the present invention.

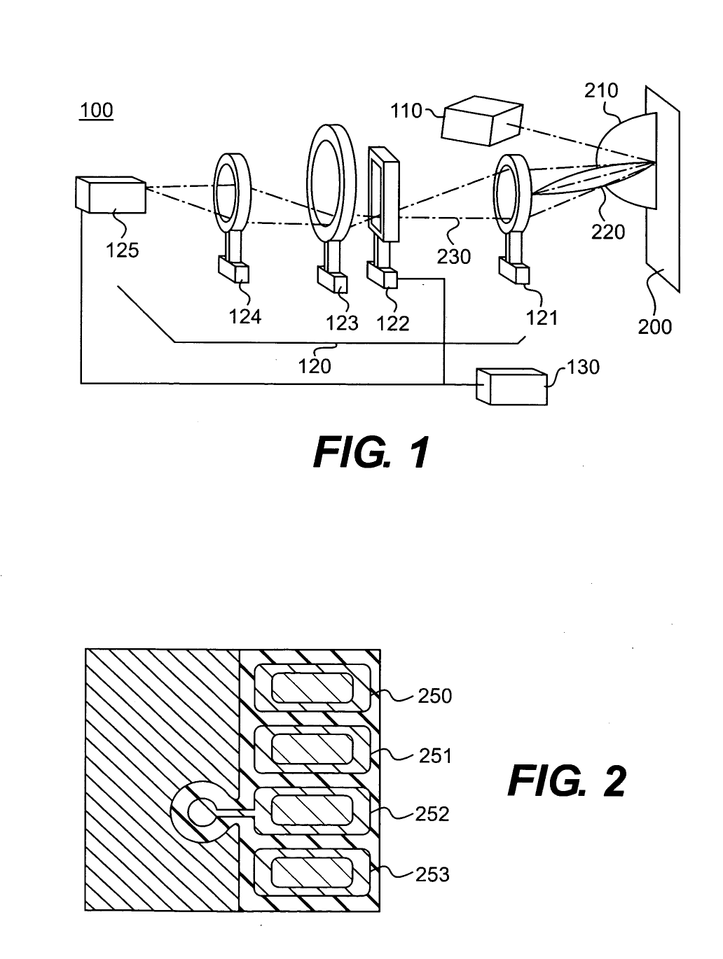

FIG. 1 is a schematic view showing a constitution of an imaging system for shape measurement of partially-specular object and an influence by the specular lobe of an object according to one embodiment of the present invention.

Referring to FIG. 1, an imaging system 100 for shape measurement of a partially-specular object according to the present embodiment is constituted to perform the shape measurement of the partially-specular object by using an imaging optical system capable of controlling attenuation rate through a spatial light modulator and an active optical measurement method.

That is, the imaging system 100 for shape measurement of a partially-specular object according to the present embodiment comprises the imaging optical system constituted by a luminous means 110 for optical measurement and a light receiving means 120 for obtaining image information, and a controlling means 130 controlling attenuation rate by using a spatial light modulator 122 in the imaging optical system to measure the shape measurement of the partially-specular object.

Herein, the light receiving means 120 is constituted by an objective lens 121, the spatial light modulator 122, a relay lens 123, an imaging lens 124, and a camera 125.

A process of measuring the shape of the partially-specular object 200 by using the imaging system 100 for shape measurement of the present embodiment will be described below.

As shown in FIG. 1, light reflected from the surface of the partially-specular object 200 may be largely divided into a diffuse lobe 210 and a specular lobe 220.

The partially specular surface means a surface on which the mixed two lobes described above are displayed. If the specular lobe is incident on an entrance pupil of the imaging optical system, the strong light of the specular lobe is incident on the camera 125 causing light saturation and blooming.

In order to prevent this, the present embodiment is constituted to control light quantity generated by the specular lobe 220 incident on the camera 125 by using the spatial light modulator 122.

That is, the spatial light modulator 122 is positioned on an imaging surface where the object is first imaged in order to control, per pixel, the light quantity formed on a CCD plane (image plane) for the camera 125 that is the second imaging surface

Accordingly, in the present embodiment if light is projected to the partially-specular object 200 by means of the luminous means 110, the light is transmitted to the objective lens 121 along an optical path 230 so that it is formed on the first imaging surface. The spatial light modulator 122 that is the optical modulation system is positioned on the first imaging surface so that the attenuation rate of pixels corresponding to the points light-saturated in a camera is controlled.

More specifically, the light forms the image on the camera 125 through the spatial light modulator 122, the relay lens 123, and the imaging lens 124.

In the present embodiment, the controlling means 130 finds the pixels wherein the light saturation occurs in the obtained image and controls the attenuation rate of the corresponding pixels in the spatial light modulator 122 so that the final image information wherein the light saturation and the blooming do not occur and the shape information of the object using this information can be obtained.

Also, the imaging system 100 for shape measurement of the present embodiment may adopt a method of positioning the spatial light modulator 122 to be slightly deviated from the imaging surface since the pixels themselves in the spatial light modulator 122 are imaged on the camera 125 when the spatial light modulator 122 is positioned on an accurate imaging surface.

Also, the present embodiment measures the shape of the object by interpreting the finally obtained image by means of an active vision measurement method.

As the aforementioned optical measurement method, a phase measuring profilometry may be applied by way of example. This can be used to obtain the three-dimensional shape information of the object by interpreting a change in a fringe pattern projected on the surface of the object.

Accordingly, the present embodiment illustrates the shape measurement of the partially-specular object 200 by obtaining the accurate fringe pattern image wherein the light saturation and the blooming are removed through the spatial light modulator 122 using the fringe pattern.

However, the present invention is not necessarily limited thereto. The known active optical measurement methods such as a phase based profiling method, a laser structured light method, and a shape from shading method may be applied.

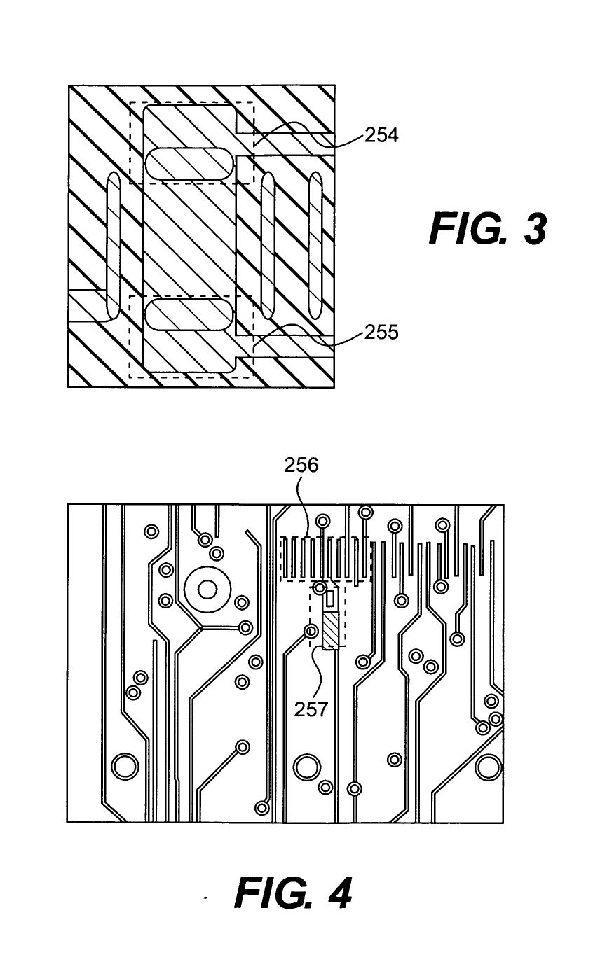

FIGS. 2 and 3 are photographs showing a state where the fringe pattern is distorted by the light saturation through an image of a solder joint that is a kind of partially-specular object.

Referring to FIGS. 2 and 3, when the fringe pattern is projected on the partially-specular object 200 using the existing a phase measuring profilometry equipment, the fringe distorted by the light saturation and the blooming as in reference numerals 250 to 255 are displayed in the image.

This is caused by the light saturation and the blooming due to the specular lobe 220 of the partially specular object 200. The three-dimensional shape information of the partially-specular object 200 cannot be accurately recognized due to this distorted fringe image.

Accordingly, the present embodiment uses the spatial light modulator 122 so as not to display the fringe distorted in the image and a more precise fringe image without distortion can be obtained by controlling the attenuation rate using the spatial light modulator.

Hereinafter, an experimental result performed on the partially-specular object in order to confirm the performance of the imaging system for shape measurement of the partially-specular object according to the present embodiment will be described.

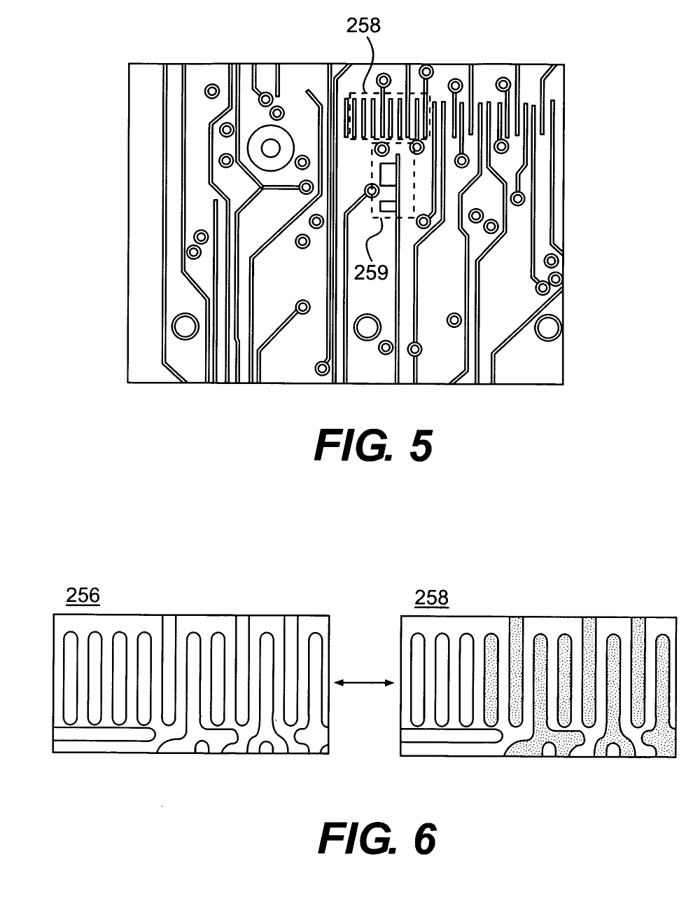

FIG. 4 is a photograph showing a printed circuit board (PCB) image in a state not controlling the attenuation rate using the spatial light modulator of FIG. 1 and FIG. 5 is a photograph showing a printed circuit (PCB) board image in a state controlling the attenuation rate using the spatial light modulator of FIG. 1.

FIG. 4 is a photograph when all light is transmitted through the spatial light modulator by not controlling the attenuation rate in the spatial light modulator 122 at all. Since the portions (reference numerals 256 and 257) surrounded by a dashed line of FIG. 4 are displayed only in white, the shape cannot be discerned through the image.

However, if the image is obtained by controlling the attenuation rate for the portions where the light saturation occurs, by using the spatial light modulator 122, it can be appreciated that the improved image is obtained as in reference numerals 258 and 259 surrounded by a dotted line in FIG. 5.

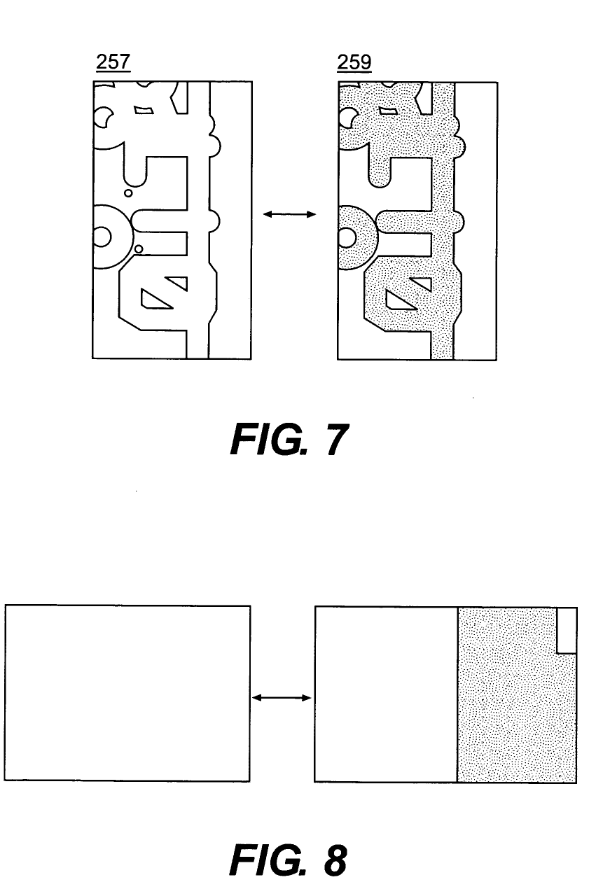

FIGS. 6 and 7 are photographs comparing an improvement effect of an image according to the control of attenuation rate by magnifying some images shown in FIGS. 4 and 5.

As shown in FIGS. 6 and 7. since it cannot previously appreciate what portions of an image are saturated, it obtains the image when all light is transmitted through the spatial light modulator 122 from the controlling means 130 through the camera 125, and then repeats a process controlling the attenuation rate of the spatial light modulator 122 by identifying the saturated position using the controlling means 130 so that the image non-saturated by the specular lobe can be obtained.

FIG. 8 is a photograph showing a light modulation mask of the spatial light modulator to obtain an image of FIG. 5 improved by the spatial light modulator.

As shown in FIG. 8, all light is transmitted in white color region of the light modulation mask. The darker color of the light modulation mask becomes, the more transmittance of light reduce.

As such, when the strong incident light generated by the specular reflection is attenuated by means of the spatial light modulator, a more precise fringe pattern is obtained. Therefore, the three-dimensional image is more accurately reproduced.

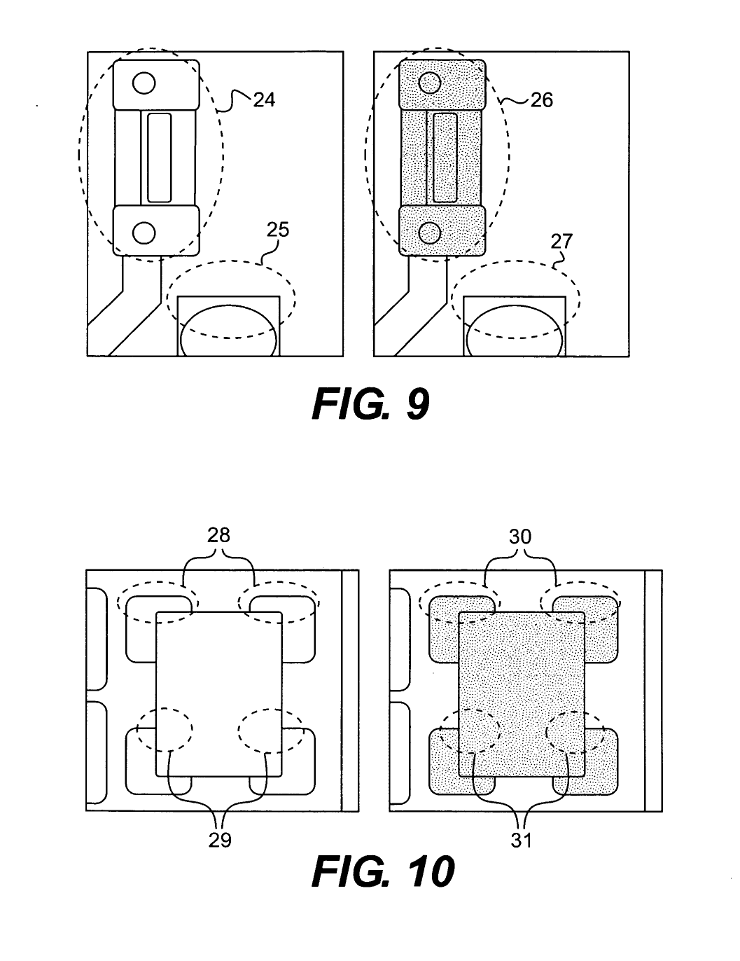

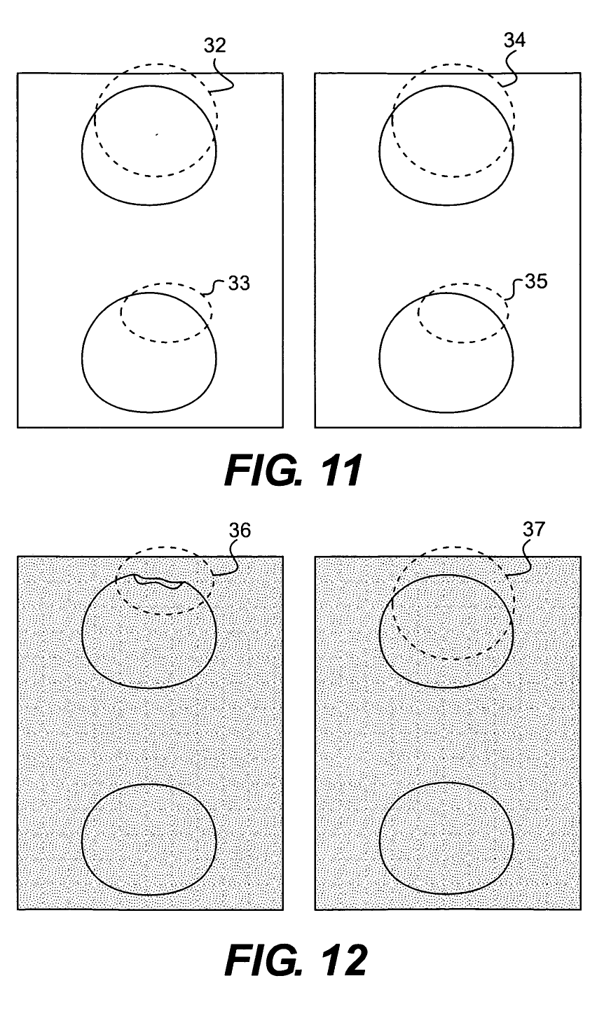

FIGS. 9 to 11 are photographs comparing an image state before and after the improvement by means of the imaging system for shape measurement of the partially-specular object according to one embodiment of the present invention; and FIG. 12 is a photograph showing a phase image of an object shape obtained by means of the imaging system for shape measurement of the partially-specular object according to one embodiment of the present invention.

In FIGS. 9 to 11, closed curve regions represented by dotted lines 24, 25, 28, 32, and 33 indicate the fringe image before the improvement and the closed curve regions represented by dotted lines 26, 27, 30, 31, 34, and 35 wherein the attenuation rate is applied through the spatial light modulator indicate an fringe image after the improvement.

Also, in FIG. 12 the closed curve region represented by a dotted line 36 indicates a phase image before the improvement and the closed curve region represented by dotted line 37 wherein the attenuation rate is applied through the spatial light modulator indicates a phase image after the improvement.

In FIGS. 9 to 12, the phase based profiling method is applied. Herein, the interference degradation is recorded with the phase change.

Accordingly, the projected pattern interference is changed by the light saturation and the blooming as shown in the closed curve regions represented by the dotted lines 24, 25, 28, 29, 32, and 33 in FIGS. 9 to 12 and the phase image directly associated with the shape of the object is not properly calculated as shown in the closed curve region represented by the dotted line 36 of FIG. 12.

On the other hand, if the problems of the saturation and the blooming are solved by controlling the transmittance using the spatial light modulator as shown in the closed curve regions represented by the dotted lines 26, 27, 30, 31, 34, and 35 in FIGS. 9 and 12, the phase image can be derived from the fringe pattern as shown in the closed curve region represented by the dotted line 37.

As described above, the present invention can perform the shape measurement on the partially-specular object wherein the shape measurement is not performed by means of the existing imaging optical system and the active optical measurement method. Accordingly, the present invention can widen the measurement range up to the partially-specular object in the state where the advantages of the active optical measurement method of contactless, rapid measurement, and high precision are maintained.

That is, since the present invention can be also applied to the case where the portion with the specular characteristic and the portion without the specular characteristic within the measurement region are mixed and can apply the measurement method known as having high precision irrespective of the specular characteristic, it has wider industrial applicability over the existing method.

Also, since the constitution of the imaging optical system is made by adding only the spatial light modulator required for measurement of the specular object to the existing active vision measurement system, the present invention can simplify the constitution and has the high measurement precision as well as can measure a wide region by applying the moire pattern or various methods in addition to the phase based profiling method, the laser structured light method, and the shape from shading method.

Further, the present invention can be applied to the shape measurement of the partially-specular object that had difficulties being obtained by a current optical measurement method so that it can be applied to the solder joint or the shape measurement of the smooth object with low surface roughness and the testing equipment, etc.

Although the technical idea of the imaging system for shape measurement of the partially-specular object of the present invention is described with reference to the accompanying drawings, this exemplarily describes the most preferred embodiment of the present invention and is not limited thereto. Also, it would be appreciated by those skilled in the art that changes might be made in this embodiment without departing from the principles and spirit of the invention.

What is claimed is:

1. An imaging system for shape measurement of a partially-specular object comprising:
a luminous means irradiating light on a surface of a partially-specular object;
a light receiving means having a spatial light modulator measuring the shape information of the partially-specular object through light reflected from the surface of the partially-specular object and controlling the attenuation rate of the points light-saturated in a camera and the corresponding pixels; and
a light receiving means having a spatial light modulator measuring the shape information of the partially-specular object through light reflected from the surface of the partially-specular object and controlling the attenuation rate of pixels corresponding the points light-saturated in a camera; and
a controlling means obtaining final image information wherein the light saturation and blooming phenomena do not occur, by identifying pixels wherein the light saturation occurs and controlling the attenuation rate of pixels in the spatial light modulator corresponding thereto.

2. The imaging system for shape measurement of a partially-specular object as claimed in claim 1, wherein the spatial light modulator is positioned on an imaging surface that is first imaged in order to control, per pixel, light quantity formed on a charge coupled device (CCD) plane for a camera that is a second imaging surface.

3. The imaging system for shape measurement of a partially-specular object as claimed in claim 1, wherein the spatial light modulator is positioned on a position slightly deviating from the imaging surface that is first imaged so that the pixel itself in the spatial light modulator is not imaged on the camera.

4. The imaging system for shape measurement of a partially-specular object as claimed in any one of claims 1, wherein the spatial light modulator controls the light quantity by the specular lobe which is reflected from the surface of the partially-specular object and incidented on camera.

5. The imaging system for shape measurement of a partially-specular object as claimed in any one of claims 2, wherein the spatial light modulator controls the light quantity by the specular lobe which is reflected from the surface of the partially-specular object and incidented on camera.

6. The imaging system for shape measurement of a partially-specular object as claimed in any one of claims 3, wherein the spatial light modulator controls the light quantity by the specular lobe which is reflected from the surface of the partially-specular object and incidented on camera.

7. A method for shape measurement of a partially-specular object using the imaging system as claimed in claim 1, comprising the steps of:
irradiating light from a luminous means on a surface of a partially-specular object;
identifying a light saturated position using a controlling means after all light reflected from the surface of the partially-specular object is transmitted through a spatial light modulator and an image at that time is obtained from the controlling means through the camera; and
obtaining final image information wherein the light saturation and the blooming do not occur and measuring the shape using this information, by controlling the attenuation rate of pixels in the spatial light modulator corresponding to CCD pixels where the light saturation occurs.

8. The method as claimed in claim 7, wherein the shape information is obtained using an active optical measurement method interpreting the final image information wherein the light saturation and the blooming do not occur.

9. The method as claimed in claim 8, wherein as the active optical measurement method, a phase measuring profilometry is used for obtaining the three-dimensional shape information of the object by interpreting a change in a fringe pattern projected on the surface of the object.
